(19) United States
(12) Patent Application Publication
(10) Pub. No.: US 2006/0081028 A1
(43) Pub. Date: Apr. 20, 2006

(54) Water soluble fertilizer having chelated micronutrients for use in fish ponds

(76) Inventor: Bob G. Hammons, Jackson, TN (US)

Correspondence Address: RICHARD A. RYAN;ATTORNEY AT LAW, 8497 N. MILLBROOK AVENUE, SUITE 101, FRESNO, CA, 93720, US

(21) Appl. No.: 10/970,647

(22) Filed: Oct. 20, 2004

(51) Int. Cl. C05D 9/00

(52) U.S. Cl. 71/31

(57) ABSTRACT

A water soluble fertilizer for use in fish ponds to enhance the growth of phytoplankton so as to increase the harvestable yield of commercial fish and reduce the quantity of aquatic weeds comprises a mixture of a N-P-K compound and one or more chelated micronutrients. Although various N-P-K compounds and chelated micronutrients can be utilized with the present invention, a preferred mixture has a N-P-K compound with a guaranteed N-P-K analysis of approximately 12-48-8 and the chelated micronutrients chelated iron, chelated copper, chelated zinc and chelated manganese. In the preferred fertilizer, one or more non-chelated micronutrients, such as boron and molybdenum, are include to further enhance the growth of phytoplankton. The chelated iron is preferably present in the range of about 0.01% to 0.3% by weight, the chelated copper, chelated zinc and chelated manganese are present in the range of about 0.01% to 0.2% by weight.

### CROSS-REFERENCE TO RELATED APPLICATIONS

None.

### BACKGROUND OF THE INVENTION

A. Field of the Invention

The field of the present invention relates generally to fertilizers and methods of their use in ponds, lakes and other aquatic ecosystems. More particularly, the present invention relates to fertilizers and fertilizing methods that are specifically adapted to improve the development of aquatic life in fish ponds and the like so as to enhance the size and quantity of commercial fish in such fish ponds. Even more particularly the present invention relates to fertilizers having chelated micronutrients and the use thereof for enhancing phytoplankton growth so as to increase commercial fish output in a fish pond.

B. Background

The use of fish ponds and other aquatic ecosystems, including lakes and the like, to raise fish for food, fishing and other commercial or private purposes is well known throughout the United States and the world. The typical fish pond is a substantially closed ecosystem of one to ten acres in size, as measured at the surface, and is used to raise commercial and/or sport fish such as trout and largemouth bass. Some fish ponds are much larger in size. The raising of fish in fish ponds and other aquatic environments, commonly referred to as aquaculture, has some of the same or similar concerns with regard to efficient and effective production of the end product as does its land-based counterpart agriculture. As with agriculture, those involved in aquaculture are concerned with the operation of the ecosystem to produce as much quantity of commercial product as can be healthily sustained in a given sized area (i.e., field, pasture or pond) at a cost and time/effort efficient manner.

Like all ecosystems, an aquatic ecosystem has a food chain cycle that makes the larger species, the desired production fish, dependant on the smaller species for food, which are in turn dependant on even smaller species of fish, insects and plants. In the typical fish pond, lake or other body of water used for raising fish for commercial or sport purposes (hereinafter collectively referred to as “fish ponds”), the base of the food chain is microscopic phytoplankton (the microscopic plants known as algae) that often gives the fish pond's water a green or olive color. The phytoplankton are primarily consumed by microscopic animals known as zooplankton. The next rung on the fish pond's food chain are insects and insect larvae, which typically consume both phytoplankton and zooplankton. The insects, and to a certain extent also the zooplankton, are consumed by small fish, such as sunfish and bluegill. The larger predator fish, such as the trout, large mouth bass and other commercial fish (hereinafter referred to collectively as “commercial fish”) consume the smaller fish, insects and zooplankton. As with other ecosystems, a healthy aquatic ecosystem for a fish pond is a careful balance between the various species in the fish pond and the pond's water environment. One specific problem is that, over time, the pond will take on the chemical make-up characteristics of the surrounding soil, which typically lacks many of the nutrients needed for a healthy aquatic ecosystem. The aquaculturist can assist with the proper balance in the fish pond by avoiding overstocking the fish pond and avoiding or preventing build-up of rooted aquatic weeds, biosolids, harmful chemicals, soil and other materials that can utilize or block uptake of the limited available oxygen, nutrients and sunlight that are necessary for optimum commercial fish production. In addition, the use of fertilizers in fish ponds is known to increase production, measured in number and size/weight, of the commercial fish.

As known to those in the aquaculture industry, fertilization of a fish pond can increase production of the microscopic phytoplankton that are beneficial and necessary, as the base of the fish pond's food chain, for the production of the desired commercial fish. It is generally well known that increasing the amount of phytoplankton in a fish pond increases the amount of food material that is available for the smaller fish and, ultimately, the harvestable commercial fish. In fact, according to certain estimates, a properly configured and applied fertilization program can triple or quadruple the commercial fish production over a similarly configured unfertilized fish pond. In addition to directly increasing the food in the food chain, by enhancing production of phytoplankton, it is also well known that a properly configured fertilization program can reduce or help control the amount of rooted aquatic weeds by facilitating the microscopic phytoplankton being sufficiently abundant that it creates a layer of phytoplankton, commonly referred to as a phytoplankton bloom, that limits sunlight penetration into the fish pond. The shading of the deeper water (i.e., typically that part of the fish pond deeper than approximately eighteen inches) provided by the phytoplankton bloom substantially prevents rooted green plants, primarily aquatic weeds, from becoming fully established, for instance to the point where their number compete with the phytoplankton for nutrients in the fish pond water.

The typical fish pond fertilizer, like a surface-use fertilizer, is a compound mixture consisting of the primary essential inorganic nutrients nitrogen, phosphorous and potassium (commonly referred to as macronutrients). As is usual in both the aquaculture and agriculture industries, the basic fertilizer is provided with in a N-P-K listing that is a short-hand description of the amount of nitrogen (N), phosphorous (P₂O₅) and potassium (K₂O) by weight. For instance, a common granular formulation for fish pond fertilization has a guaranteed analysis of 0-46-0, meaning that the fertilizer is guaranteed to have at least 46% phosphorous, by weight, and no nitrogen and potassium. A common liquid fertilizer has a guaranteed analysis of 10-34-0, meaning that it has at least 10% nitrogen, 34% phosphorous and no potassium. A common soluble fertilizer has a guaranteed analysis of 10-52-4, meaning that it has at least 10% nitrogen, 52% phosphorous and 4% potassium. The remaining percentages of the above mixtures include inert materials and various necessary binder agents. For purposes of this disclosure, the term “N-P-K compound” refers to fertilizer mixtures comprising the active inorganic macronutrients nitrogen, phosphorous and potassium.

While the N-P-K compounds used for fish pond fertilizer provides macronutrients to the phytoplankton, it does not provide all nutrients that are necessary and beneficial to the phytoplankton. Missing from the N-P-K compounds utilized in aquaculture are various inorganic micronutrients, such as iron, manganese, zinc and copper, that are known to be beneficial to plant life and which could be utilized to enhance phytoplankton production (although macronutrients and micronutrients are both inorganic nutrients, the characterizations are utilized to reference the relative amounts by which the nutrients are utilized by plants, including phytoplankton). As used herein, inorganic micronutrients include iron, manganese, zinc, copper, calcium and magnesium. Inorganic micronutrients are essential to the phytoplankton metabolic systems, providing benefits that include improved photosynthesis, cell wall formation, enzyme synthesis and translocation of sugars and starches. In addition, the inclusion of inorganic micronutrients aid in the uptake of the N-P-K compounds to assist those nutrients, the macronutrients, in providing a better balanced fertilizer. Failure of the phytoplankton to obtain one or more of inorganic micronutrients, particularly the iron, manganese, zinc and copper, can result in poor or reduced phytoplankton plant growth.

As known in the agriculture industry, providing plants with inorganic micronutrients can be done by directly mixing the micronutrients in with the N-P-K compounds. Use of such chemicals has found that plants do not absorb many of the inorganic micronutrients very well when applied directly to the plants. This is a particular problem for fish ponds in that the inorganic nutrients, which have a positive ionic charge, tend to react with the ions in the pond water to form somewhat insoluble substances that make the micronutrients generally unavailable for direct assimilation by the phytoplankton. Although the inorganic micronutrients will usually be converted by natural means into a form that is assimilable by the phytoplankton, this process is known to be slow and somewhat unpredictable, making it unsuitable for fish pond harvesting. In general agricultural applications the fertilizer industry has devised several means by which it is possible to artificially provide the desired inorganic micronutrients to plants so that it can be provided on a more continuous and sustained basis. One of the primary means utilized in the agricultural industry, but not heretofore in the aquaculture industry, to facilitate the uptake of the inorganic micronutrients are chelating agents to provide chelated micronutrients.

Chelated micronutrients are inorganic micronutrients that are substantially enclosed by an organic molecular structure that forms a comparatively weak chemical bond with the inorganic micronutrient, thereby effectively giving the micronutrient an organic coating. The organic coating is of the type that can be broken down by the plant. As a result, an effective chelating agent is one that forms a bond with the inorganic micronutrient that is strong enough to protect the enclosed micronutrient but weak enough to release the micronutrient once it gets assimilated into the plant. Because the chelating agent is absorbed into the plant, it must be of the type that is not harmful to the plants being fertilized. There are a number of natural chemicals that are used in the industry as chelating agents, including lignin sulfonates, glucoheptonates, phenols, polyslavinoids, citric acid and various other organic acids. In addition to the various natural chemicals, there are a number of commercially available synthetic substances that are useful as chelating agents to chelate inorganic nutrients, including ethylene diamine tetraacetate (EDTA), diethylene triamine pentaacetate (DTPA) and ethylene diamine dihydroxyphenyl acetate (EDDHA). Of the synthetic chelating agents, EDTA is generally considered the most effective, available and economical for use with inorganic micronutrients. As used herein, the term “chelating agent” refers any of the above-referenced natural or synthetic compounds that are suitable for appropriately bonding to a inorganic micronutrient (metal ion) and which is biologically acceptable to the desired plants and animals in the target ecosystems. The term “chelated micronutrients” refers to those compounds that comprise an inorganic micronutrient which is substantially enclosed, coated, bonded or otherwise reacted with a chelating agent to form a compound that is configured to provide a more biologically acceptable form for uptake of the micronutrient into the desired plants.

Although the use of chelated micronutrients are commonly utilized in the agricultural industry to deliver micronutrients to surface plants, it is believed by the present inventor that they have not heretofore been utilized in conjunction with fish ponds to stimulate and maintain effective phytoplankton growth for the purpose of increasing yields of commercial fish in the fish pond. As set forth above, because phytoplankton is the base of the pond's food chain, increasing the growth of phytoplankton will have the effect of increasing zooplankton, insects, small fish and, ultimately, the quantity of harvestable commercial fish. What is needed, therefore, is a water soluble fertilizer having chelated micronutrients for use in fish ponds to increase the quantity of phytoplankton and enhance the production of commercial fish. The preferred fertilizer will comprise a N-P-K compound that is enhanced with the addition of one or more chelated micronutrients incorporated therewith. The preferred fertilizer will be optimized to with selected N-P-K compound and chelated micronutrients configured to provide enhanced phytoplankton production in a fish pond. In addition to the above, the preferred fertilizer will be provided in a form that is substantially water soluble and able to relatively rapidly mix in the water to avoid intermixing of the micronutrients with the soil in the fish pond. The ideal chelating agent for use with the preferred fertilizer will be one that is substantially fully dissolvable by the plant so that the micronutrient will be effectively released therein. Ideally, the preferred fertilizer will be one that is relatively economical to manufacture, easy to apply and made from generally commercially available materials.

### SUMMARY OF THE INVENTION

The water soluble fertilizer having chelated micronutrients for use in fish ponds of the present invention solves the problems and provides the benefits identified above. That is to say, the present invention discloses a new and improved fertilizer for use with fish ponds to enhance the production of phytoplankton so as to increase the production of commercial fish in the fish pond. The fertilizer of the present invention comprises a N-P-K compound that is mixed with one or more chelated micronutrients to provide a biologically effective uptake of the fertilizer by the phytoplankton so as to enhance its production and the production of the zooplankton, insects, small fish and commercial fish which depend on the phytoplankton as the base of the food chain. The fertilizer of the preferred invention is configured to be provided in a generally fully soluble form so that it will effectively mix with the fish pond water to substantially distribute the fertilizer throughout the fish pond. The fertilizer of the present invention preferably utilizes EDTA as a chelating agent to deliver chelated micronutrients, such as chelated iron, chelated copper, chelated manganese and chelated zinc, to biologically provide these micronutrients to the phytoplankton so as to enhance its growth.

In one general aspect of the present invention, the water soluble fertilizer having chelated micronutrients for use in fish ponds comprises a N-P-K compound mixed with one or more chelated micronutrients. Exemplary of such a fertilizer product is a fertilizer having a guaranteed N-P-K analysis of 12-48-8 with chelated copper, chelated iron, chelated manganese and/or chelated zinc. The chelated iron is preferably present in the range of about 0.01% to 0.3% by weight and the chelated copper, chelated zinc and chelated manganese are present in the range of about 0.01% to 0.2% by weight. In the preferred embodiment of the fertilizer of the present invention, each of these chelated micronutrients are present in the above-referenced ranges. Also in a preferred embodiment the fertilizer comprises a N-P-K compound, one or more chelated micronutrients and one or more non-chelated micronutrients, such as boron and molybdenum, which are present in the range of about 0.005% to 0.1% by weight for the boron and about 0.0001% to 0.001% by weight for the molybdenum. The preferred fertilizer comprises a water soluble granular mixture of a N-P-K compound, the chelated micronutrients chelated copper, chelated iron, chelated manganese and chelated zinc, and the non-chelated micronutrients boron and molybdenum. A method of treating a fish pond comprises the steps of providing a fertilizer mixture having a N-P-K compound and one or more chelated micronutrients, all of which are selected for use in the fish pond so as to promote growth of phytoplankton therein, and then dispersing the fertilizer in the fish pond so as to substantially dissolve the fertilizer mixture in the fish pond water. In the preferred method of the present invention, the N-P-K compound comprises has a guaranteed analysis of approximately 12-48-8, chelated iron, chelated copper, chelated zinc and chelated manganese, all in the ranges set forth above, and the non-chelated micronutrients boron and molybdenum, also in the ranges set forth above.

Accordingly, the primary objective of the present invention is to provide a water soluble fertilizer having chelated micronutrients for use in fish ponds that provides the advantages discussed above and that overcomes the disadvantages and limitations associated with presently available fertilizers configured for use in fish ponds.

It is also an object of the present invention to provide a water soluble fertilizer having chelated micronutrients for use in fish ponds that comprises a mixture of a N-P-K compound and one or more chelated micronutrients to enhance the size/weight gain of the commercial fish harvested from the fish pond.

It is also an object of the present invention to provide a water soluble fertilizer having chelated micronutrients for use in fish ponds that comprises a mixture of a N-P-K compound and one or more chelated micronutrients that utilize EDTA as the chelating agent.

It is also an object of the present invention to provide a water soluble fertilizer having chelated micronutrients for use in fish ponds that comprises a guaranteed analysis having approximately 10% to 15% nitrogen, 45% to 50% phosphorous and 5% to 10% potassium that is mixed with one or more chelated micronutrients that utilize a chelating agent, such as EDTA, which is substantially dissolvable in the phytoplankton that is the base of the fish pond's food chain so as to increase the size of the commercial fish therein.

It is also an object of the present invention to provide a water soluble fertilizer having chelated micronutrients for use in fish ponds that comprises a mixture of a guaranteed analysis of approximately 12-48-8 utilizing EDTA iron, EDTA copper, EDTA manganese and/or EDTA zinc as micronutrients.

The above and other objectives of the present invention will be explained in greater detail by reference to the description of the preferred embodiment which follows. As set forth herein, the present invention resides in the novel features of form, construction, mode of operation and combination of processes presently described and understood by the claims.

### DETAILED DESCRIPTION OF THE PREFERRED EMBODIMENTS

With reference to the detailed description set forth below, and particularly with reference to the embodiments of the fertilizer of the present invention set forth below, the present invention sets forth an improved water soluble fertilizer having chelated micronutrients for use in fish ponds. The enclosed description is merely illustrative of the preferred embodiments and represent several different ways of configuring the present invention. Although specific components, materials, configurations and uses of the present invention are illustrated and set forth in this disclosure, it should be understood that a number of variations to the components and to the configuration of those components described herein can be made without changing the scope and function of the invention set forth herein.

As set forth above, a healthy fish pond ecosystem for producing the greatest quantity of commercial fish sustainable by the fish pond depends upon having a balanced food chain that is configured to provide, ultimately, sufficient food for the commercial fish to thrive so as to be harvestable in the desired quantities. The base of the fish pond food chain is the microscopic green plants or algae known as phytoplankton. The phytoplankton supports the other aquatic life, including microscopic animals, insects, smaller fish species and the commercial fish. As with all living plants, the growth rate and ability of the phytoplankton to be a food source for the other aquatic life is highly dependent on its own ability to obtain the nutrients it needs to thrive. In addition, a healthy population of phytoplankton also establishes a phytoplankton bloom that can be effective at reducing the growth and, therefore, the nutrient robbing ability of rooted aquatic weeds. The ability of the aquaculturalist to raise commercial fish in a fish pond is improved by his or her ability to establish a healthy amount of phytoplankton, an objective that is typically achievable only through the addition of fertilizers to the fish pond.

The standard fish pond fertilizer is a N-P-K compound that provides varying amounts of nitrogen, phosphorous and potassium to the aquatic ecosystem. The levels of these nutrients are chosen in an attempt to achieve the optimum level of phytoplankton growth in a particular fish pond so that the highest sustainable level of commercial fish production is possible. With regard to water soluble fertilizers, typical guaranteed analyses are 10-52-4 and 12-49-6. While these standard fish pond fertilizers are known to improve the production of commercial fish in the typical fish pond, they are not necessarily configured to obtain the optimum production of commercial fish. Through analysis of various fish pond environments, the inventor of the present invention has determined that a N-P-K compound having a guaranteed analysis of 12-48-8 achieves improved fish production. As set forth below, this N-P-K compound is achieved by utilizing nitrate, ammoniscal and urea nitrogen, phosphoric acid and potash. While use of this particular or similarly configured N-P-K compound alone does improve the aquatic ecosystem, primarily by increasing the quantity of phytoplankton, it still does not address the fact that the water in many fish ponds are deficient or become deficient, particularly over time, in the trace inorganic nutrients that are necessary to stimulate and maintain effective photosynthetic phytoplankton growth in the fish pond.

To enhance the growth of phytoplankton in a fish pond, and ultimately the size and weight of the commercial fish to be harvested therefrom, the present invention incorporates a mixture of a N-P-K compound and one or more chelated micronutrients. As defined above, inorganic micronutrients include iron, manganese, zinc, copper, calcium, boron and molybdenum. The various micronutrients are known to have different beneficial effects for different types of plants that require use of one or combinations of the micronutrients depending on the chemical make-up of the subject ecosystem. For the present invention, the inventor has analyzed phytoplankton to determine what combination of micronutrients will provide the most benefit to the phytoplankton so as to achieve the food and bloom benefits described above. Although it would be possible to mix all of the desired micronutrients, without any type of chelating coating, with a preferred N-P-K compound, it is generally known that coating certain of the micronutrients (i.e., iron, manganese, zinc and copper) with an organic material to produce chelated micronutrients improves the uptake of those micronutrients into surface plants. The present inventor had found that this same concept is also applicable to enhancing phytoplankton growth in fish ponds. The micronutrients boron and molybdenum, which are derived from sodium borate and molybdenum is derived from sodium molybdate respectively, are examples of micronutrients that are not typically chelated. Hereinafter, such micronutrients are referred to as “non-chelated micronutrients” for purposes of this disclosure.

The preferred chelating agent for the fertilizer of the present invention is one that is substantially fully dissolvable by phytoplankton so that it will effectively release substantially all of the micronutrients and make them available for stimulating the growth of the phytoplankton. The strongly preferred chelating agent for the fertilizer of the present invention is EDTA. While other chelating agents can perform the chelating function and be utilized with the fertilizer of the present invention, none of the presently known natural or synthetic chelating agents are believed to perform as well as EDTA. The various EDTA micronutrient materials are generally available with varying levels of metal concentrations. For the present invention, it is preferred that the chelated micronutrients (i.e., copper, zinc, manganese and iron) have metal ion concentrations in the 10% to 20%, by weight.

Although fertilizers can be provided in liquid or granular forms, the preferred fertilizer of the present invention is a granular fertilizer made of water soluble materials that are configured to be readily dissolvable in the upper portion of the fish pond water. Preferably, the improved fertilizer of the present invention will be able to be fully dissolvable in approximately the upper two feet of the fish pond water to better encourage phytoplankton growth and optimum bloom development. Granular fertilizers can be applied to the fish pond by spreading the fertilizer from the shore, a pier or a boat into portions of the fish pond where the water depth is sufficient to facilitate dissolving of the fertilizer in the water prior to contacting the soil under the water.

One aspect of the novelty of the present invention is a fertilizer product combining a typical N-P-K compound with one or more chelated micronutrients and applying the product to a fish pond to enhance the growth of phytoplankton and, ultimately the quantity of harvestable commercial fish from the fish pond. According to the principles and objectives of the present invention, an example fertilizer product is set forth below to further illustrate the present invention and the method of preparing the same. The following example is just one example representative of various similarly adapted fertilizer products that can be provided according to the present invention. The example is for illustrative purposes only and is not intended to restrict the invention to the specific formulation set forth below or to the particular materials utilized in that formulation.

### EXAMPLE

The following fertilizer product is mixed in a controlled environment, such as an enclosed room, where the humidity can be kept to a minimum to avoid absorption of moisture by some of the chemical compositions used herein. As known to those skilled in the art, some of the below-identified chemicals will rapidly absorb moisture, turning the chemicals into a lumpy or sticky mess not preferably suitable for use as a soluble fertilizer. The following active granular fertilizer components are mixed, with the percentages listed by weight:

| N—P—K Compound: | |
|---|---|
| Total nitrogen | 12.0% |
| Nitrate nitrogen | 8.9% |
| Ammoniscal nitrogen | 2.4% |
| Urea nitrogen | 0.7% |
| Phosphorous Acid (P₂O₅) | 48.0 |
| Potash (K₂O) - water soluble | 8.0% |
| Chelated Micronutrients: | |
| Copper (Cu) - Chelated copper (15%) | 0.05% |
| Iron (Fe) - Chelated iron (13%) | 0.10% |
| Manganese (Mn) - chelated manganese (14%) | 0.05% |
| Zinc (Zn) - chelated zinc (14%) | 0.05% |
| Other Micronutrients: | |
| Boron (B) - from sodium borate | 0.02% |
| Molybdenum (Mo) - from sodium molybdate | 0.0005% |

Although a specific composition of micronutrients, chelated micronutrients and non-chelated micronutrients are set forth in the table above, the inventor has determined that there is a range of such materials that can be included with a N-P-K compound to achieve the objectives of the present invention. For instance, the following ranges for the chelated micronutrients and non-chelated micronutrients is acceptable for the fertilizer of the present invention:

| Micronutrient | Range |
|---|---|
| Chelated iron | 0.01% to 0.3% |
| Chelated Copper | 0.01% to 0.2% |
| Chelated Zinc | 0.01% to 0.2% |
| Chelated Manganese | 0.01% to 0.2% |
| Boron | 0.005% to 0.1% |
| Molybdenum | 0.0001% to 0.001% |

Likewise, the N-P-K compound for use with the present invention can have a substantial range and still accomplish the objectives of the present invention. In one alternative embodiment, the guaranteed analysis is a compound having a 12-54-4 make-up. As known to those skilled in the art, various other possible combinations of N-P-K compounds can be utilized with the micronutrients, and more specifically the chelated micronutrients, set forth above.

The chemical components above are mixed together, in addition to applicable inert materials and binder agents known to those skilled in the art, to form a substantially uniform granular mixture and then placed into containers for delivery to and use by persons who fertilize fish ponds (i.e., fish pond owners and/or contract personnel). In a preferred embodiment, a 25 pound quantity of the fertilizer mixture is placed into plastic bags, which are then placed into boxes for delivery. The above mixture has been found to enhance growth of phytoplankton as the base of the food chain and facilitate the formation of a healthy phytoplankton bloom to control the growth of aquatic weeds. As desired, use of the fertilizer of the present invention results in an increase in phytoplankton that provides benefits up the entire fish pond food chain, including an increase in size and weight of the commercial fish to be harvested therefrom.

Depending on the geographical location of the fish pond, the typical fish pond will require fertilizing in late February or early March when the water temperatures approach approximately 70 degrees Fahrenheit. The user of the fertilizer of the present invention applies fertilizer to the fish pond at the rate of approximately five pounds per acre, as measured at the surface, by dumping or otherwise placing the fertilizer into the fish pond water from the shore, pier or a boat. As discussed above, to ensure its effectiveness, the fertilizer should be placed into the fish pond at locations where the water is two or more feet deep to prevent interaction between the fertilizer and the soil at the bottom of the pond. In one method, the user merely opens the 25 pound bag of granular fertilizer and pours out all or part of the fertilizer into the fish pound, depending on how big the fish pound is (i.e., 25 pound bag will fertilize a five acre fish pond utilizing the five pounds of fertilizer per acre application rate). Typically, it will be necessary to treat the fish pond with the fertilizer approximately every two weeks until the fish pond produces the desired green or olive bloom. Once the phytoplankton bloom is achieved, the operator of the fish pond will reapply fertilizer, at the rates discussed above, when the water visibility exceeds approximately eighteen inches (meaning there is less phytoplankton making up the bloom), as measured from the surface using a Secchi disk or other mechanism for measuring visibility in water.

While there are shown and described herein certain specific alternative forms of the invention, it will be readily apparent to those skilled in the art that the invention is not so limited, but is susceptible to various modifications and rearrangements of chemical materials and methods of use without departing from the spirit and scope of the present invention. In particular, it should be noted that the present invention is subject to modification with regard to the chemical make-up of the N-P-K compound and which chelated micronutrients are utilized in the fertilizer of the present invention.

What is claimed is:

1. A water soluble fertilizer for application to a fish pond, said fertilizer comprising:
a N-P-K compound selected for use in said fish pond; and
one or more chelated micronutrients.

2. The fertilizer according to claim 1, wherein said one or more chelated micronutrients are selected from the group consisting of chelated iron, chelated copper, chelated zinc and chelated manganese.

3. The fertilizer according to claim 2, wherein said N-P-K compound comprises approximately 12% nitrogen, approximately 48% phosphorous and approximately 8% potassium by weight of said fertilizer.

4. The fertilizer according to claim 1, wherein said fertilizer comprises a plurality of said one or more chelated micronutrients, said plurality of said one or more chelated micronutrients selected from the group consisting of chelated iron in the range of about 0.01% to 0.3% by weight, chelated copper in the range of about 0.01% to 0.2% by weight, chelated zinc in the range of about 0.01% to 0.2% by weight and chelated manganese in the range of about 0.01% to 0.2% by weight.

5. The fertilizer according to claim 4, wherein said N-P-K compound comprises approximately 12% nitrogen, approximately 48% phosphorous and approximately 8% potassium by weight of said fertilizer.

6. The fertilizer according to claim 4 further comprising one or more non-chelated micronutrients, said one or more non-chelated micronutrients selected from the group consisting of boron in the range of about 0.005% to 0.1% by weight and molybdenum in the range of about 0.0001% to 0.001% by weight.

7. The fertilizer according to claim 1 further comprising one or more non-chelated micronutrients.

8. The fertilizer according to claim 7, wherein said one or more non-chelated micronutrients are selected from the group consisting of boron and molybdenum.

9. The fertilizer according to claim 1, wherein said one or more chelated micronutrients comprises chelated iron, said chelated iron being present in the range of about 0.01% to 0.3% by weight of said fertilizer.

10. The fertilizer according to claim 1, wherein said one or more chelated micronutrients comprises chelated copper, said chelated copper being present in the range of about 0.01% to 0.2% by weight of said fertilizer.

11. The fertilizer according to claim 1, wherein said one or more chelated micronutrients comprises chelated zinc, said chelated zinc being present in the range of about 0.01% to 0.2% by weight of said fertilizer.

12. The fertilizer according to claim 1, wherein said one or more chelated micronutrients comprises chelated manganese, said chelated manganese being present in the range of about 0.01% to 0.2% by weight of said fertilizer.

13. The fertilizer according to claim 1, wherein said N-P-K compound comprises approximately 12% nitrogen, approximately 48% phosphorous and approximately 8% potassium by weight of said fertilizer and said one or more chelated micronutrients comprises chelated iron, chelated copper, chelated zinc and chelated manganese.

14. The fertilizer according to claim 13, wherein said chelated iron is present in the range of about 0.01% to 0.3% by weight, said chelated copper is present in the range of about 0.01% to 0.2% by weight, said chelated zinc is present in the range of about 0.01% to 0.2% by weight and said chelated manganese is present in the range of about 0.01% to 0.2% by weight.

15. The fertilizer according to claim 14 further comprising one or more non-chelated micronutrients, said one or more non-chelated micronutrients comprising boron in the range of about 0.005% to 0.1% by weight and molybdenum in the range of about 0.0001% to 0.001% by weight.

16. A water soluble fertilizer for application to a fish pond, said fertilizer comprising:
a N-P-K compound selected for use in said fish pond;
one or more chelated micronutrients, said one or more chelated micronutrients selected from the group consisting of chelated iron, chelated copper, chelated zinc and chelated manganese; and
one or more non-chelated micronutrients, said one or more non-chelated micronutrients selected from the group consisting of boron and molybdenum.

17. The fertilizer according to claim 16, wherein said chelated iron is present in the range of about 0.01% to 0.3% by weight, said chelated copper is present in the range of about 0.01% to 0.2% by weight, said chelated zinc is present in the range of about 0.01% to 0.2% by weight and/or said chelated manganese is present in the range of about 0.01% to 0.2% by weight.

18. The fertilizer according to claim 17, wherein said N-P-K compound comprises approximately 12% nitrogen, approximately 48% phosphorous and approximately 8% potassium by weight of said fertilizer.

19. The fertilizer according to claim 18, wherein said boron is present in the range of about 0.005% to 0.1% by weight and/or said molybdenum is present in the range of about 0.0001% to 0.001% by weight.

20. A method of treating a fish pond with a water soluble fertilizer, said method comprising the steps of:
a) providing said fertilizer in a fertilizer mixture comprising a N-P-K compound and one or more chelated micronutrients, said N-P-K compound and said one or more chelated micronutrients selected for use in said fish pond so as to promote growth of phytoplankton therein; and
b) dispersing said fertilizer in said fish pond so as to substantially dissolve said fertilizer mixture in the water of said fish pond.

21. The method according to claim 20, wherein said one or more chelated micronutrients selected from the group consisting of chelated iron, chelated copper, chelated zinc and chelated manganese.

22. The method according to claim 21, wherein said chelated iron is present in the range of about 0.01% to 0.3% by weight, said chelated copper is present in the range of about 0.01% to 0.2% by weight, said chelated zinc is present in the range of about 0.01% to 0.2% by weight and/or said chelated manganese is present in the range of about 0.01% to 0.2% by weight.

23. The method according to claim 21, wherein said N-P-K compound comprises approximately 12% nitrogen, approximately 48% phosphorous and approximately 8% potassium by weight of said fertilizer.

24. The method according to claim 21, wherein said fertilizer mixture further comprises one or more non-chelated micronutrients.

25. The method according to claim 24, wherein said one or more non-chelated micronutrients are selected from the group consisting of boron and molybdenum.
